(19) United States
(12) Patent Application Publication
(10) Pub. No.: US 2015/0077646 A1
(43) Pub. Date: Mar. 19, 2015

(54) Touch Sensitive Display With Graded Index Layer

(71) Applicant: Apple Inc., Cupertino, CA (US)

(72) Inventors: Jinghong Chen, Milpitas, CA (US); Matthew S. Rogers, San Jose, CA (US); Cheng Chen, San Jose, CA (US); Enkhamgalan Dorjgotov, San Francisco, CA (US); Sunggu Kang, San Jose, CA (US); Kai Wang, San Jose, CA (US); Kuo-Hua Sung, San Jose, CA (US)

(73) Assignee: Apple Inc., Cupertino, CA (US)

(21) Appl. No.: 14/028,878

(22) Filed: Sep. 17, 2013

(51) Int. Cl. G06F 1/16

(52) U.S. Cl. CPC G06F 1/1643
USPC 349/12

(57) ABSTRACT

An electronic device may have a touch screen display or other input-output device that includes transparent conductive electrodes. The transparent conductive electrodes may be formed from a material that has a relatively high index of refraction such as indium tin oxide. Surrounding layers of the touch screen display such as a touch sensor substrate and an underlying display layer may have lower index of refraction values. To prevent abrupt index-of-refraction discontinuities that lead to unwanted reflections and visible artifacts on the display, the transparent conductive electrodes may be embedded within a dielectric layer. The dielectric layer may have a graded index of refraction. The graded index of refraction may be varied continuously or in a stepwise fashion by adjusting the composition of materials that are incorporated into the dielectric layer as a function of position within the layer.

### BACKGROUND

This relates generally to electronic devices and, more particularly, to electronic devices with touch screen displays.

Electronic devices often include displays. For example, cellular telephones and computers have displays.

Displays in electronic devices sometimes incorporate touch sensor functionality. As an example, a display may be provided with a touch sensor that is formed from an array of transparent capacitive touch sensor electrodes. During operation of an electronic device, a touch sensor may be used in gathering touch input from a user.

To ensure that the electrodes of a capacitive touch sensor array do not block light that is being emitted from the display, the electrodes are formed from a transparent conductive material such as indium tin oxide.

Indium tin oxide capacitor electrodes are typically supported by a clear substrate such as a layer of glass or plastic. The index of refraction of indium tin oxide is relatively high compared to these substrate materials. As a result, there is a significant index-of-refraction mismatch between the capacitive touch sensor electrodes and the substrate. If care is not taken, the index-of-refraction mismatch may give rise to increased reflection from the touch screen display and visible artifacts on the display from the presence of the patterned capacitive touch sensor electrodes.

It would therefore be desirable to be able to provide improved touch screen displays for electronic devices.

### SUMMARY

An electronic device may have a touch screen display or other input-output device that includes transparent conductive electrodes. The transparent conductive electrodes may be used in forming an array of capacitive touch sensor electrodes for a touch sensor that overlaps display layers associated with a display.

The transparent conductive electrodes may be formed from a material that has a relatively high index of refraction such as indium tin oxide. Surrounding layers of the touch screen display such as a touch sensor substrate for the touch sensor and an underlying display layer associated with a liquid crystal display or organic light-emitting display may have lower index of refraction values. For example, a substrate in the touch screen display may have an index of refraction in the range of 1.5 to 1.7 and a display layer in a display such as a liquid crystal display or organic light-emitting diode display may have an index of refraction of about 1.5, whereas transparent conductive electrodes for a touch sensor that are formed from indium tin oxide may have an index of refraction of about 1.9.

Some touch sensor electrodes may be relatively large (e.g., several millimeters in width or more) and therefore may have the potential to be visible to a user of an electronic device. To prevent abrupt index-of-refraction discontinuities that lead to unwanted reflections and visible artifacts on the display, the transparent conductive electrodes may be embedded within a dielectric layer that has a varying index of refraction.

The dielectric layer may have a graded index of refraction. The graded index of refraction may be varied continuously or in a stepwise fashion by adjusting the composition of materials that are incorporated into the dielectric layer as a function of position within the layer. As an example, the graded index-of-refraction layer may be produced from a mixture of silicon oxide (which has an index of refraction of 1.5) and a metal oxide with an index of refraction of more than 2.0 (as an example). By adjusting the ratio between the silicon oxide and the metal oxide (or other high-index material), the index of refraction of the dielectric layer can be adjusted as a function of position in the dielectric layer.

The graded index-of-refraction dielectric layer may have an index of refraction that is matched to that of a touch sensor substrate within portions of the dielectric layer that are adjacent to the substrate, may have an index of refraction that is matched to that of the transparent conductive capacitive touch sensor electrodes within portions of the dielectric layer that are adjacent to the electrodes, and may have an index of refraction that is matched to that of the underlying display (i.e., the display layers that are overlapped by the touch sensor) within portions of the dielectric layer that are adjacent to the underlying display. The index of refraction of the dielectric layer may increase monotonically between the substrate and the electrodes and may increase monotonically between the underlying display and the electrodes.

Use of a graded index dielectric layer in a touch screen display may reduce reflections from the display and may help minimize display discoloration effects during off-axis viewing.

### BRIEF DESCRIPTION OF THE DRAWINGS

FIG. 1 is a perspective view of an illustrative electronic device such as a laptop computer with a touch screen display in accordance with an embodiment.

FIG. 2 is a perspective view of an illustrative electronic device such as a handheld electronic device with a touch screen display in accordance with an embodiment.

FIG. 3 is a perspective view of an illustrative electronic device such as a tablet computer with a touch screen display in accordance with an embodiment.

FIG. 4 is a perspective view of an illustrative electronic device such as a display for a computer or television with a touch screen display in accordance with an embodiment.

FIG. 5 is an illustrative diagram showing how touch sensor processing circuitry may be coupled to a display having transparent capacitive touch sensor electrodes in accordance with an embodiment.

FIG. 6 is a cross-sectional side view of illustrative touch screen display layers in accordance with an embodiment.

FIG. 7 is a diagram showing how a touch screen display may be provided with a dielectric layer having a graded index of refraction that helps reduce index-of-refraction mismatch effects arising from the presence of capacitive touch sensor electrodes in accordance with an embodiment.

FIG. 8 is a graph in which the magnitude of color change associated with a display is plotted as a function of angular orientation with respect to a surface normal for the display for conventional and graded index configurations in accordance with an embodiment.

FIG. 9 is a graph in which reflection from capacitive touch sensor electrodes in a display has been plotted as a function of wavelength for a conventional touch screen display and a display in which a graded index has been used to help reduce electrode reflections in accordance with an embodiment.

### DETAILED DESCRIPTION

Electronic devices may be provided with input-output devices such as touch screen displays. Components such as touch screen displays may be formed from multiple layers of material. For example, a touch screen display may have one or more display layers for producing visible images for a user and one or more layers that form a touch sensor. Displays may also be provided with protective cover layers such as a cover glass layer or a plastic display cover layer.

In forming an input-output device for an electronic device such as a touch screen display, it may be desirable to form patterned structures from a material that has an index of refraction that differs from its surroundings. When forming a capacitive touch sensor for a display, for example, it may be desirable to form an array of patterned transparent conductive electrodes on a transparent substrate. The array of patterned transparent conductive electrodes may be formed from a transparent conductive material such as indium tin oxide on a transparent substrate such as a layer of glass or plastic.

The index of refraction of indium tin oxide is 1.9, whereas the index of refraction of glass is about 1.5. Due to the index-of-refraction mismatch between indium tin oxide and glass of the substrate on which the indium tin oxide electrodes are formed, there is a potential for undesired reflections and visible artifacts.

To minimize the visibility of structures in an input-output device such as a touch screen display due to index-of-refraction mismatch, the material surrounding the high index of refraction material can be configured to have a graded index of refraction. The presence of the graded index in the vicinity of the indium tin oxide electrodes helps to reduce index mismatch at the interface between the indium tin oxide electrodes and surrounding materials and thereby helps reduce reflections and visible artifacts.

The graded index of refraction may be produced by using a continuously or stepwise varying mixture of high and low index materials. As an example, the graded index of refraction may be produced by depositing a continuously varying (or stepwise varying) mixture of silicon oxide (SiO₂) and niobium oxide (Nb₂O₅). The deposited mixture may have an index of refraction of close to that of glass at the interface with the glass substrate by adjusting the mixture to include mostly silicon oxide. Near the interface between the deposited mixture and the indium tin oxide electrodes, more niobium oxide may be incorporated into the mixture to raise the index of refraction to match that of indium tin oxide (1.9). The index profile associated with the graded index may have endpoints that match the index of adjoining layers. For example, the upper (outermost) portion of the graded index material may have an index that matches the index of an overlapping substrate on which the indium tin oxide electrodes are formed and the lower (innermost) portion of the graded index material may have an index that matches the index of refraction of a display layer in an underlying display module.

A graded index of refraction region may be used to reduce reflections and visible artifacts in a stand-alone touch sensor, in a touch sensor that is incorporated into a display to form a touch screen display, in a display without a touch sensor that contains one or more traces of material with a potentially mismatched index of refraction, in a display in which touch sensor layers are attached to display layers with adhesive or other attachment mechanisms, in a display in which touch sensor and display features are formed using one or more shared display layers or in other suitable input-output device structures. Configurations in which a graded index of refraction region is formed as part of a touch screen display to help conceal capacitive touch sensor electrodes are sometimes described herein as an example.

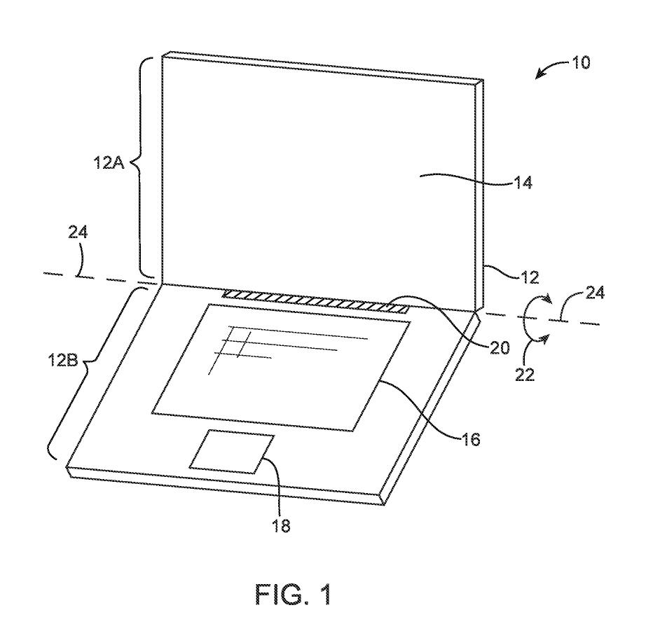

Illustrative electronic devices that have touch sensor displays with graded index regions are shown in FIGS. 1, 2, 3, and 4.

Electronic device 10 of FIG. 1 has the shape of a laptop computer and has upper housing 12A and lower housing 12B with components such as keyboard 16 and touchpad 18. Device 10 has hinge structures 20 (sometimes referred to as a clutch barrel) to allow upper housing 12A to rotate in directions 22 about rotational axis 24 relative to lower housing 12B. Display 14 is mounted in housing 12A. Upper housing 12A, which may sometimes referred to as a display housing or lid, is placed in a closed position by rotating upper housing 12A towards lower housing 12B about rotational axis 24.

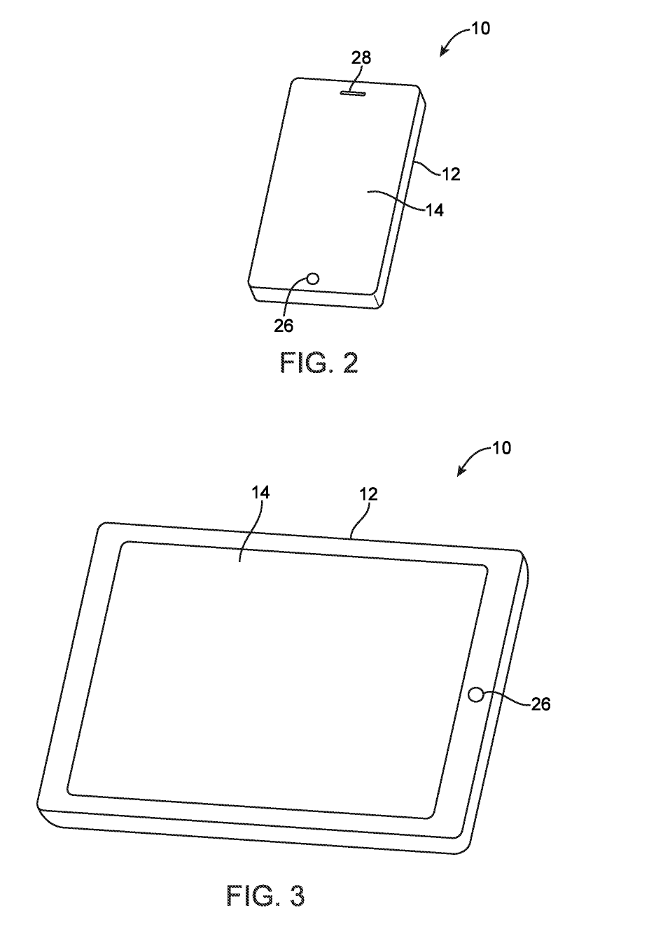

FIG. 2 shows an illustrative configuration for electronic device 10 based on a handheld device such as a cellular telephone, music player, gaming device, navigation unit, or other compact device. In this type of configuration for device 10, housing 12 has opposing front and rear surfaces. Display 14 is mounted on a front face of housing 12. Display 14 may have an exterior layer that includes openings for components such as button 26 and speaker port 28.

In the example of FIG. 3, electronic device 10 is a tablet computer. In electronic device 10 of FIG. 3, housing 12 has opposing planar front and rear surfaces. Display 14 is mounted on the front surface of housing 12. As shown in FIG. 3, display 14 has an external layer with an opening to accommodate button 26.

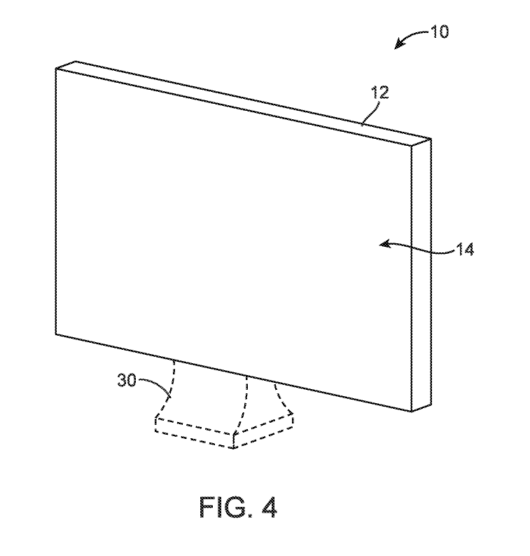

FIG. 4 shows an illustrative configuration for electronic device 10 in which device 10 is a computer display, a computer that has an integrated computer display, or a television. Display 14 is mounted on a front face of housing 12. With this type of arrangement, housing 12 for device 10 may be mounted on a wall or may have an optional structure such as support stand 30 to support device 10 on a flat surface such as a table top or desk.

Displays such as the displays of FIGS. 1, 2, 3, and 4 may incorporate a touch sensor. The touch sensor may be a capacitive touch sensor formed from an array of transparent capacitive touch sensor electrodes. The electrodes may be formed from a material such indium tin oxide or other material that is transparent and conductive. The electrodes may be patterned in one or more layers (e.g., using a one-sided touch sensor arrangement or a two-sided touch sensor arrangement). The electrodes may have the shape of squares, rectangles, elongated strips, diamonds, or other shapes and may be connected in rows, columns, and other patterns. Touch sensor arrays may be formed from transparent electrodes that are integrated into the layers of a display (e.g., by forming transparent conductive electrodes and display electrodes from shared structures on a common substrate) and/or may be formed on a touch sensor substrate that is attached to a display module using adhesive (as an example). Illustrative touch screen display configurations in which a display module is attached to a touch sensor panel using a layer of adhesive are sometimes described herein as an example.

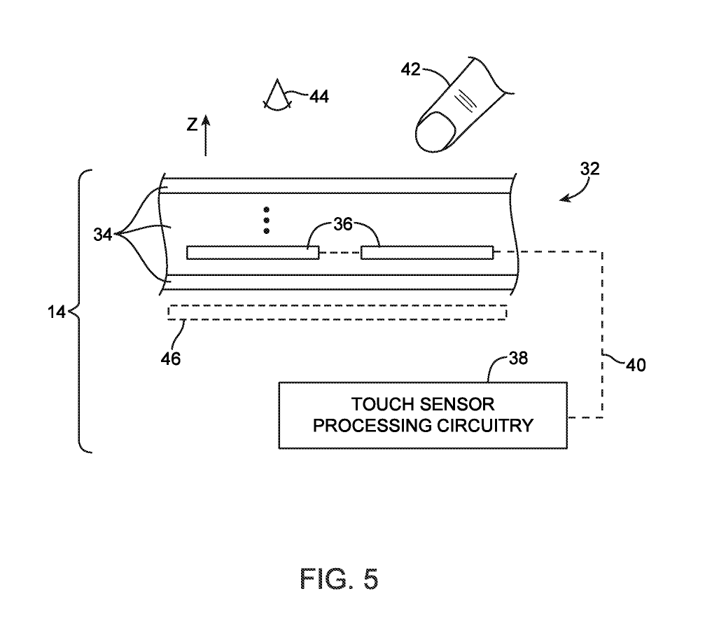

FIG. 5 is a diagram showing how a touch sensor such as touch sensor 32 may be formed from one or more touch sensor display layers 34. Touch sensor 32 may be formed as part of a display, as a stand-alone touch sensor, etc. In configurations in which touch sensor 32 forms a touch sensor for a display, touch sensor 32 can be attached to a display cover layer and/or a display module (e.g., a liquid crystal display module, an organic light-emitting diode display, an electrophoretic display, etc.). Touch sensor 32 may be transparent to allow images from display layers such as optional display layers 46 that are mounted under touch sensor 32 to travel upward in direction Z to be viewed by viewer 44. In configurations in which display layers 46 are present, the structures of FIG. 5 may be used to form touch screen display 14.

Touch sensor display layers 34 may include, for example, a substrate layer of a transparent material such as glass or plastic, optional coatings, layers of transparent dielectric that serve as electrical isolation layers between deposited conductive layers, etc. Touch sensor layers 34 may include touch sensor electrodes 36. Touch sensor electrode 36 may include patterned conductive electrodes that serve as capacitive electrodes in a capacitive touch sensor.

Conductive paths 40 may be used to couple touch sensor electrodes 36 to touch sensor processing circuitry 38. Touch sensor processing circuitry 38 may use electrodes 36 to gather touch input associated with an external object such as external object 42 (e.g., a user's finger).

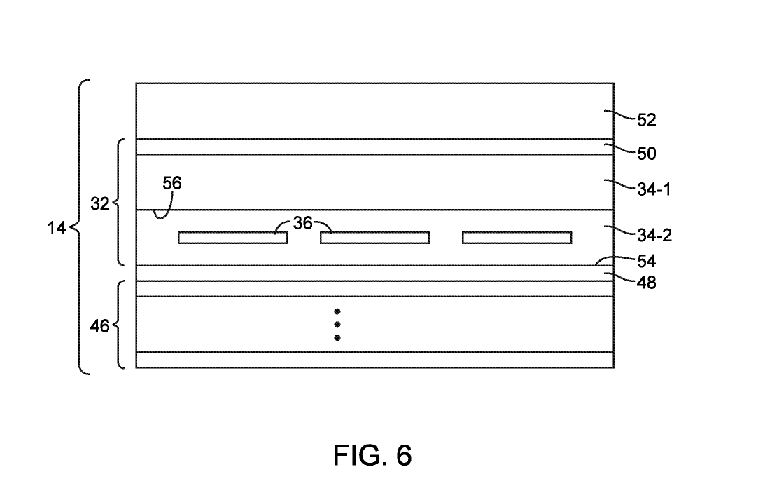

FIG. 6 is a cross-sectional side view of display 14 in an illustrative configuration in which display 14 has a protective display cover layer and a touch sensor (i.e., a configuration in which display 14 is a touch screen display). As shown in FIG. 6, display 14 includes display layers 46. Display layers 46 may include liquid crystal display layers, organic light-emitting diode display layers, display layers in an electrophoretic display, display layers associated with a plasma display, or other suitable display layers. Display layers 46 may be mounted in housing structures 12, in a plastic chassis structure and/or a metal chassis structure, or other suitable support structures. Display layers 46 may sometimes be referred to as forming a display or display module (e.g., a liquid crystal display or display module, an organic light-emitting diode display or display module, an electrophoretic display or display module, etc.). In a liquid crystal display, layers 46 may include upper and lower polarizer layers, a color filter layer and a thin-film transistor layer between the upper and lower polarizer layers, and a layer of liquid crystal material sandwiched between the color filter layer and the thin-film transistor layer. An organic light-emitting diode display module may be implemented using a rigid substrate (e.g., a rigid glass or plastic substrate and/or a flexible substrate). Organic light-emitting diode display layers may be implemented using top emission or bottom emission designs.

Adhesive 48 such as pressure sensitive adhesive or optically clear liquid adhesive may be used in attaching display layers 46 to touch sensor 32. Touch sensor 32 may have a substrate layer such as substrate 34-1. Substrate 34-1 may be a planar layer of clear glass (e.g., a rectangular sheet of glass), a layer of transparent plastic, ceramic, multiple layers of transparent dielectric, or other suitable material. Substrate 34-1 may be formed above or below electrodes 36. In the example of FIG. 6, electrodes 36 have been patterned on the lower side of substrate 34-1. This is merely illustrative. If desired, electrodes 36 may be formed on the upper side of substrate 34-1 or on both the upper and lower sides of substrate 34-1.

Electrodes 36 may be embedded within graded index layer 34-2. Graded index layer 34-2 may be formed from a transparent dielectric such as a mixture of silicon oxide and dielectric that has a higher index of refraction than silicon oxide. Silicon oxide has an index of refraction of 1.5. Dielectric materials that have an index of refraction higher than silicon oxide include niobium oxide, tantalum oxide, titanium oxide, other metal oxides, oxynitrides, silicon nitride, etc.

The index of refraction of indium tin oxide is 1.9. When touch sensor electrodes 36 are formed from a material such as indium tin oxide, touch sensor electrodes 36 may therefore have an index of refraction that is relatively large relative to the index of material of surrounding materials. Graded index layer 34-2 preferably has an index profile that helps minimize reflections at the interface between lower surface 54 of graded index layer 34-2 and adhesive 48 and/or display layers 46. For example, if display layers 46 (i.e., a polarizer layer or other plastic or glass layer in layers 46) and/or adhesive layer 48 have and index of refraction of 1.5, graded index layer 34-2 is preferably configured to have an index of refraction of about 1.5 at surface 54. Graded index layer 34-2 preferably also has an index profile that helps minimize reflections at the interface between upper surface 56 of graded index layer 34-2 and the corresponding lower surface of substrate layer 34-1. For example, if substrate 34-1 is formed from glass having an index of refraction of 1.55, graded index layer 34-2 preferably has an index of about 1.55 at upper surface 56. If substrate 34-1 is formed form a material with a larger index of refraction such as sapphire, which has an index of refraction of 1.7, graded index layer 34-2 preferably has an index of refraction of about 1.7 at upper surface 56.

At intermediate positions within graded index layer 34-2 (i.e., midway between upper surface 56 and lower surface 54 in the vicinity of electrodes 36), graded index layer 34-2 preferably has an index of refraction that is matched to the index of refraction of electrodes 36 (i.e., an index of refraction of about 1.9 to match the index of refraction of indium tin oxide).

Optional display cover layer 52 may be formed form a layer of glass or plastic (e.g., glass or plastic that is index matched to substrate 34-1 when substrate 34-1 is formed from glass or plastic), may be formed from a layer of material having a higher index of refraction (e.g., sapphire), or may be formed from other suitable materials. Adhesive layer 50 (e.g., a layer of pressure sensitive adhesive or optically clear liquid adhesive) may be used to attach display cover layer 52 to touch sensor 32.

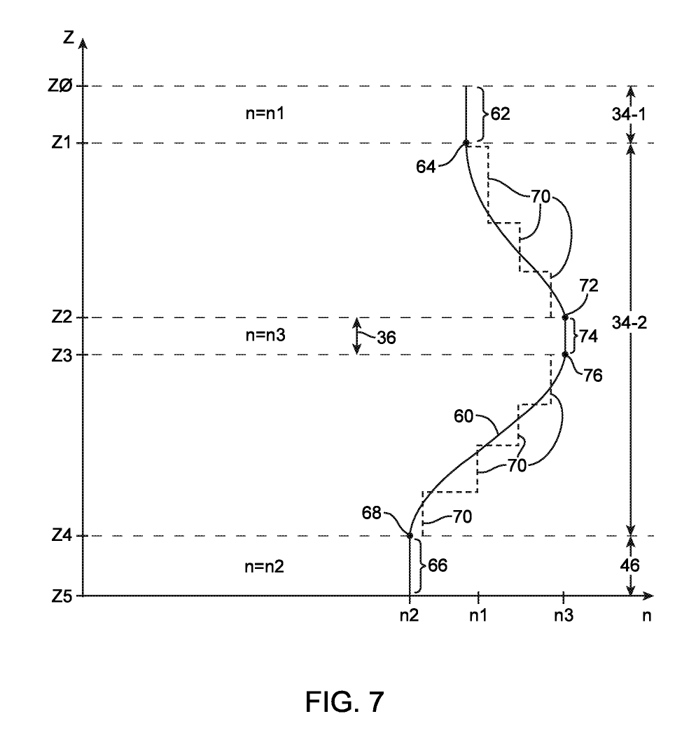

FIG. 7 is a graph showing how the index of refraction n may vary as a function of vertical position z through display layers 46, graded index layer 34-2 (including embedded indium tin oxide touch sensor electrode 36), and substrate layer 34-1. Because substrate layer 34-1 is one of the layers in display 14, substrate layer 34-1 may sometimes be referred to as a display layer.

Graded index layer 34-2 may have a continuously graded profile as illustrated by continuously varying index of refraction profile 60 or may have a stepwise varying index of refraction profile as illustrated by stepped index of refraction profile 70. There may be any suitable number of discrete steps in a stepped index of refraction profile (e.g., two or more, three or more, four or more, five or more, six or more, ten or more, twenty or more, etc.) each formed from a respective sublayer of transparent dielectric material with a corresponding index of refraction in graded index layer 34-2. The number of illustrative discrete sublayers of material used to form steps 70 of FIG. 7 is merely illustrative. Continuous profile 60 and/or stepped profile 70 may by formed using deposition techniques such as sputtering. The total thickness of layer 34-2 may be, for example, 100 nm (e.g. 10 nm to 1 micron, etc.).

Electrodes 36 may be buried within layer 34-2 (i.e., electrodes 36 may be formed at a location that is about midway vertically through layer 34-2). Upper display layer 34-1 (e.g., a glass or sapphire substrate layer or other display layer) may have an upper surface at position Z0 and a lower surface at position Z1. Between Z0 and Z1, layer 34-1 has an index of refraction of n1, as illustrated by index of refraction profile segment 62. At point 64, the index of refraction of graded index layer 34-2 is exactly or approximately matched to the index of refraction n1 of layer 34-1. In a continuously variable graded index configuration, for example, the index of refraction of graded index layer 34-2 is preferably close to or equal to n1 at point 64, as shown by line 60. The value of n1 may be 1.5 (e.g., for glass or plastic), 1.6, 1.7 (e.g., for sapphire), less than 1.75, 1.6 to 1.8, less than 1.7, less than 1.6, 1.4 to 1.6, less than 1.8, etc.

The index of refraction of electrodes 36 is n3. When, for example, electrodes 36 are formed from indium tin oxide, the value of n3 is about 1.9. Other values of n3 that may be associated with electrodes 36 include values in the range of 1.8 to 2.0, more than 1.7, more than 1.8, more than 1.85, less than 1.95, 1.8 to 2.0, less than 2.0, etc. Between point 64 and point 72, the index of refraction of graded index layer 34-2 preferably increases monotonically (i.e., graded index layer 34-2 exhibits an ever-increasing magnitude when transitioning between point 64 and point 72). At point 72, the index of refraction of graded index layer 34-2 is exactly or approximately matched to the index of refraction of touch sensor electrode 36. In a continuously variable graded index configuration, for example, the index of refraction of graded index layer 34-2 is preferably close to or equal to n3 at point 72.

Between positions Z2 and Z3, the index of refraction of electrode 36 is fixed at n3, as illustrated by line segment 74. At point 76, the index of refraction of graded index layer 34-2 is preferably matched (exactly or approximately) to the index of refraction of touch sensor electrode 36. For example, in a continuously variable graded index configuration, the index of refraction of graded index layer 34-2 is preferably close to or equal to n3 at point 76.

Between point 76 and 68, the index of refraction in graded index of refraction layer 34-2 preferably decreases monotonically (i.e., the index of refraction is ever decreasing at decreasing values of position Z and the index of refraction is monotonically increasing as Z increases when transitioning between point 68 and 76). At point 68, the index of refraction of graded index layer 34-2 is exactly or approximately matched to the index of refraction of display layers 46. If, for example, layers 46 (e.g., the uppermost layer/layers 46) have an index of refraction of n2 between heights Z4 and Z5 as indicated by line segment 66, the index of refraction of graded index layer 34-2 may be exactly or approximately equal to n2 at point 68. In a continuously variable graded index configuration, for example, the index of refraction of graded index layer 34-2 is preferably close to or equal to n2 at point 68. The value of n2 may be 1.5, less than 1.5, 1.6, less than 1.6, or other suitable value.

The index of refraction of adhesive layers 50 and 48 of FIG. 6 can generally be neglected when matching the index of graded index layer 34-2 to the index of refraction values n1 and n2, as the adhesive layers are relatively thin and have index of refraction values that are close to those of layers 34-1 and 46, respectively.

With the arrangement of FIG. 7, index of refraction discontinuities, which can lead to undesired reflections and visible artifacts, are minimized. For example, index mismatch between layer 34-1 and layer 34-2 is minimized by reducing mismatch at position Z1 (point 64). The smooth, monotonically increasing index values between point 64 and 72 avoid abrupt large index of refraction discontinuities and thereby avoid reflections. Index mismatch between layer 34-2 and electrodes 36 is minimized by reducing mismatch at position Z2 (point 72). Index mismatch between electrodes 36 and layer 34-2 is minimized by reducing mismatch at position Z3 (point 76). The smoothly varying index values between points 76 and 68 avoid undesired index of refraction discontinuities and associated reflections. Index of refraction mismatch at point 68 is also avoided by matching the index of refraction of graded index layer 34-2 to index n2 of layer 46.

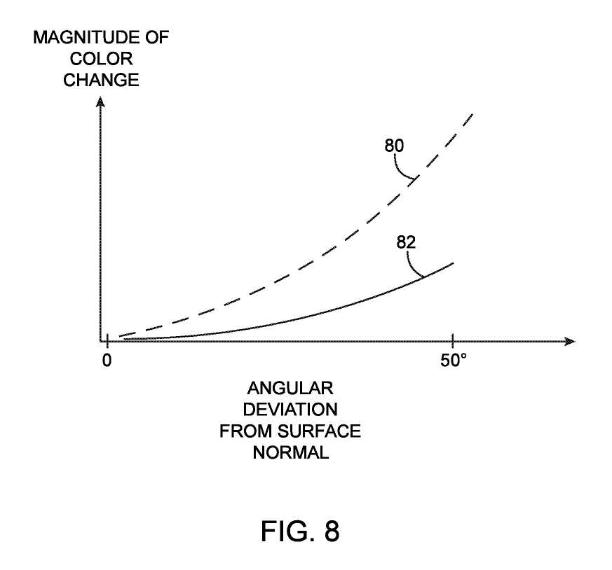

FIG. 8 is a graph in which the magnitude of color change that is exhibited by a display during off-axis viewing has been plotted as a function of viewing angle (i.e., angular deviation in degrees as measured from the surface normal to the display). In conventional displays without a graded index layer, off-angle viewing tends to result in substantial display discoloration, as illustrated by dashed line 80, particularly at large off-axis viewing angles of 40° or more. This discoloration is due to interference effects resulting from the index of refraction mismatch between indium tin oxide touch sensor electrodes (index of 1.9) and surrounding display layers (index 1.5). The sharp index discontinuities experienced between the layers of conventional displays create significant amounts of reflection, interference, and off-axis display discoloration.

Line 82 of the graph of FIG. 8 corresponds to the magnitude of color change expected in display 14 of device 10 (e.g., a display of the type shown in FIG. 7) in which touch sensor electrodes 36 are embedded within an appropriately configured graded index of refraction layer 34-2. As illustrated by the lower values of line 82 relative to line 80, when display 14 is provided with a graded index of refraction layer adjacent to electrodes 36, reflections and resulting interference that can lead to color change artifacts can be substantially suppressed.

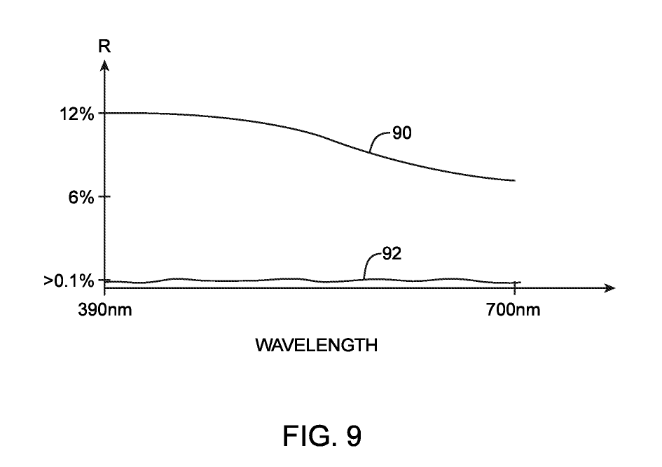

FIG. 9 is a graph in which the amount of reflection from a display has been plotted as a function of wavelength. The graph of FIG. 9 covers visible light wavelengths ranging from 390 nm to 700 nm. Line 90 corresponds to reflection from a conventional display without a graded index layer (i.e., a display in which indium tin oxide touch sensor electrodes are adjacent to a material with an index of refraction that is substantially different than the index of refraction of indium tin oxide such as glass). As illustrated by line 90, this type of arrangement can result in significant reflections from display 14—ranging from about 12% at blue wavelengths to about 6% at red wavelengths. The reflections are sufficiently large and the size of the indium tin oxide touch sensor electrodes in a conventional touch sensor display are typically sufficiently large that the electrodes may be visible to user.

Line 92 illustrates how much reflected light from display 14 is expected when using a graded index adjacent to touch sensor electrodes 36. As demonstrated by this example, less than 0.1% reflection is expected from electrodes 36 in scenarios in which electrodes 36 are buried within a graded index layer such as layer 34-2 of FIG. 7. This eliminates reflections from electrodes 36 and thereby makes electrodes 36 invisible to the user of device 10. Because reflections from electrodes 36 are suppressed, a user of electronic device 10 will not observe undesired visible artifacts on display 14 when a graded index layer is incorporated (i.e., a stepwise graded index or a continuously varying graded index).

The foregoing is merely illustrative and various modifications can be made by those skilled in the art without departing from the scope and spirit of the described embodiments. The foregoing embodiments may be implemented individually or in any combination.

What is claimed is:

1. Apparatus, comprising:
a graded index-of-refraction layer; and
a touch sensor electrode embedded within the graded index-of-refraction layer.

2. The apparatus defined in claim 1 further comprising:
a first transparent layer;
a second transparent layer, wherein the graded index-of-refraction layer is interposed between the first transparent layer and the second transparent layer.

3. The apparatus defined in claim 2 wherein the graded index-of-refraction layer has an index of refraction that monotonically increases between the first transparent layer and the touch sensor electrode and that monotonically increases between the second transparent layer and the touch sensor electrode.

4. The apparatus defined in claim 3 wherein the first transparent layer has a first index of refraction, wherein the second transparent layer has a second index of refraction, and wherein the graded index-of-refraction layer has an index of refraction at the first transparent layer that is matched to the first index of refraction and has an index of refraction at the second transparent layer that is matched to the second index of refraction.

5. The apparatus defined in claim 4 wherein the touch sensor electrode has a third index of refraction and wherein the graded index-of-refraction layer has an index of refraction at the touch sensor electrode that is matched to the third index of refraction.

6. The apparatus defined in claim 5 wherein the first transparent layer comprises a material selected from the group consisting of: glass, plastic, and sapphire.

7. The apparatus defined in claim 6 wherein the second transparent layer comprises a layer in a liquid crystal display.

8. The apparatus defined in claim 6 wherein the second transparent layer comprises a layer in an organic light-emitting diode display.

9. A touch screen display, comprising:
a touch sensor electrode that has a first index of refraction and that is embedded in a dielectric layer; and
a display layer having a second index of refraction that is different than the first index of refraction, wherein the dielectric layer overlaps the display layer and wherein the dielectric layer has an index of refraction that varies between the first index of refraction at the touch sensor electrode and the second index of refraction at the display layer.

10. The touch screen display defined in claim 9 wherein the display layer comprises a layer in a liquid crystal display.

11. The touch screen display defined in claim 9 wherein the touch sensor electrode comprises an indium tin oxide electrode.

12. The touch screen display defined in claim 9 further comprising a display cover layer that covers the dielectric layer.

13. The touch screen display defined in claim 9 further comprising a substrate layer on which the dielectric layer is formed.

14. The touch screen display defined in claim 13 wherein the substrate layer has a third index of refraction and wherein the dielectric layer has an index of refraction that increases monotonically from the third index of refraction at the substrate layer to the first index of refraction at the touch sensor electrode.

15. The touch screen display defined in claim 14 wherein the dielectric layer is characterized by a continuously varying graded index of refraction profile and wherein the index of refraction of the dielectric layer increases monotonically between the first index of refraction at the touch sensor electrode and the second index of refraction at the display layer.

16. An electronic device, comprising:
a housing;
a display in the housing; and
a touch sensor that overlaps the display, wherein the touch sensor has a substrate, has a graded index-of-refraction dielectric layer on the substrate, and has conductive transparent capacitor electrodes embedded in the graded index-of-refraction dielectric layer.

17. The electronic device defined in claim 16 wherein the display comprises a display layer that is adjacent to the graded index-of-refraction layer and wherein the display layer has an index of refraction of less than 1.6.

18. The electronic device defined in claim 17 wherein the graded index-of-refraction dielectric layer is interposed between the substrate and the display layer and wherein the substrate has an index of refraction of less than 1.8.

19. The electronic device defined in claim 18 wherein the conductive transparent capacitor electrodes have an index of refraction of more than 1.8.

20. The electronic device defined in claim 19 wherein:
the display comprises a display selected from the group consisting of: a liquid crystal display and an organic light-emitting diode display;
the substrate is selected from the group consisting of: glass and sapphire;
the transparent capacitor electrodes comprise indium tin oxide; and
the graded index-of-refraction layer comprises a varying mixture of silicon oxide having a silicon oxide index of refraction and a dielectric material having an index of refraction greater than the silicon oxide index of refraction.
